(19) United States
(12) Patent Application Publication
(10) Pub. No.: US 2011/0111236 A1
(43) Pub. Date: May 12, 2011

(54) Method for Treating and Sticking Work Pieces Made of Metal or a Metal Alloy Comprising a Hydrated Oxide and/or Hydroxide Layer

(76) Inventors: Dennis Pahl, Ruhen (DE); Norman Blank, Ruschlikon (CH); Uwe Hartmann, Horn-Bad Meinberg (DE); Michael Stege, Wolfsburg (DE)

(21) Appl. No.: 11/632,463

(22) PCT Filed: Jul. 13, 2005
(86) PCT No.: PCT/EP2005/007623

§ 371 Date: Dec. 2, 2008

(30) Foreign Application Priority Data
Jul. 13, 2004 (DE) 10 2004 033 728.4

(51) Int. Cl. B32B 15/04; C25D 5/00; B05D 5/10; B05D 3/06

(52) U.S. Cl. 428/457; 205/114; 427/207.1; 427/534; 427/554; 427/558; 427/535

(57) ABSTRACT

A method for treating a bond area of a workpiece, and a method for adhesively bonding workpieces are disclosed. The method for treating a bond area of a workpiece includes cleaning the bond area, activating the bond area, coating at least a portion of the bond area with an adhesion promoter, and chemically transforming the adhesion promoter with an aftertreatment. The method for adhesively bonding workpieces includes cleaning a bond area of a first workpiece, activating the bond area, coating at least a portion of the bond area with an adhesion promoter, chemically transforming the adhesion promoter with an aftertreatment, applying an adhesive to the bond area, bringing the other workpiece into contact with the first workpiece, and curing the adhesive.

### CROSS-REFERENCE TO RELATED APPLICATIONS

This application is a National Phase application claiming the benefit of International Application No. PCT/EP2005/007623, filed Jul. 13, 2005, which claims priority based on Application No. DE 10 2004 033 728.4, filed Jul. 13, 2004, the complete disclosures of which are incorporated herein by reference in their entireties.

### BACKGROUND

The disclosure relates to a method for treating a bond area of a workpiece made from a metal or metal alloy having a hydrated oxide and/or hydroxide layer, and also to a method of adhesively bonding two workpieces, at least one workpiece being composed of a metal or metal alloy having a hydrated oxide and/or hydroxide layer, the workpieces each having at least one bond area.

Apart from the noble metals, the majority of metals and metal alloys have a hydrated oxide and/or hydroxide layer. Metals or metal alloys having a hydrated oxide and/or hydroxide layer are in widespread use in industry, particularly in industrial manufacturing.

These materials have to date been joined by traditional joining methods such as riveting, welding or screwing, for example. It has been found, however, that a variety of drawbacks are associated with these traditional joining methods. When the assembly is under load, for example, there are very high stress peaks at the join sites. Furthermore, traditional assemblies of this kind may be subject to corrosion, especially when different materials are joined. Finally, nonferrous metal materials in particular, and especially aluminum, are generally not suited for welding to other materials.

The joining of materials by bonding using adhesives is generally known. An adhesive is generally a nonmetallic material which joins workpieces to one another by surface attachment (adhesion) and interior strength (cohesion).

Adhesive bonding has numerous advantages in comparison to other joining methods such as riveting, welding and screwing. For example, adhesives promote a uniform distribution of stress over the entire bond area, which is beneficial for both static and dynamic strength of the bond. Moreover, there is generally no damage to the surface and microstructure. In addition, adhesives may provide a sealing function. A further advantage comes into play particularly in the context of lightweight construction, since the use of adhesives allows a considerable weight saving. Not least, it is possible, using adhesives, to join different materials to one another.

For reliable and load-bearing adhesive bonding of materials, howevera problem is posed by a hydrated oxide and/or hydroxide layer that is typically formed in ambient air on metals or metal alloys. These naturally occurring layers may propagate in an irregular and inexactly defined process, and contain oxides, hydroxides, and sometimes also oxyhydroxides, often present as a mixture as well.

Owing to the different structures of the products formed, surfaces which have propagates in this way typically have undulations or pores in which it is easy for water to become lodged. In the topmost layer at least, hydration occurs. This superficial layer may result in poor attachment and adhesion to the surface of the material, and can lead to unpredictable detachment phenomena or ruptures within this oxide and/or hydroxide layer during loading. Moreover, the surface structure and hydration may lead, in the case of adhesive bonding, to what is known as a “weak boundary layer”, and hence to the premature failure of an adhesive bond between these workpieces.

The bond areas must also remain free of corrosion, so that the adhesive bond is not impaired by a reaction of the metal or metal alloy with moisture from the environment, between the adhesive and the bond area, and does not fail under long-term loading.

A further problem of these surfaces—even if additional treatment methods are used to apply a defined oxide layer, as is the case for example with Eloxal (electrically oxidized aluminum)—is that, owing to the low surface energy, it is difficult to carry out complete wetting of the oxide layer with an adhesive. Consequently the bond areas are not adequately joined to one another.

Accordingly, there is a need for an improved adhesive bonding process for workpieces made of metals or metal alloys having a hydrated oxide and/or hydroxide layer.

### DETAILED DESCRIPTION

According to various embodiments, a method for treating a bond area of a workpiece made of a metal or metal alloy having a hydrated oxide and/or hydroxide layer is disclosed.

A method for treating a bond area of a workpiece made of a metal or metal alloy with hydrated oxide and/or hydroxide layer may include the following steps:
cleaning a bond area,
activating the bond area,
coating the bond area at least partly with an adhesion promoter, and
aftertreating the adhesion promoter.

A metal or metal alloy with hydrated oxide and/or hydroxide layer may include titanium, vanadium, chromium, manganese, iron, cobalt, nickel, copper, zinc, tin, magnesium, aluminum and their alloys with one another or their alloys with other alloying ingredients such as silicon or carbon. Among the alloys, various steels and aluminum alloys may be employed. Nonferrous metal materials may also be utilized, such as aluminum, magnesium or titanium materials. Finally, materials such as silicon and silicon oxide (glass) may also have an oxide and/or hydroxide layer, and therefore likewise be employed.

Various embodiments are described below with reference to aluminum as the material. However, in general, any metals or metal alloys having a hydrated oxide and/or hydroxide layer may be used.

Aluminum materials are materials with diverse possible uses, and are obtaining an ever-increasing share of sectors such as vehicle production, for example. Besides vehicle construction, other areas in which aluminum materials are used include, for example, the construction of aircraft, for architectural components, particularly for facing components or window frames, or for the production of furniture or household appliances. One reason for this increasing share at the expense of other metals is aluminum's relatively low weight.

Aluminum materials are produced in a variety of adaptations for their subsequent use. In vehicle construction, aluminum material may be composed in particular of an aluminum panel, an extruded aluminum profile or a diecast aluminum alloy. One alloy in vehicle construction is composed of an aluminum-magnesium-silicon compound (AlMgSi). This compound may be coated, after processing, by a coating method, such as cathodic electrodeposition coating after passivation by pickling, and durably protected against environmental effects.

In other applications, aluminum material may be exposed to environmental effects without a further coating. In these cases, the aluminum material may be provided with a protective oxide layer in a controlled procedure by means of electrolytic oxidation. A material of this kind is also known as Eloxal (electrically oxidized aluminum).

Prior to application of an adhesion promoter the bond area may be pretreated, i.e., cleaned and activated. As a result of this, the bond area is in a largely defined condition. The surface of the bond area should predominantly, and preferably almost completely, have no surface layer of undefined structure.

Cleaning and activating of the bond area can take place either by means of a plasma treatment or of an abrasive mechanical treatment. In the case of plasma treatment, an oxide layer of the metal or metal alloy, particularly the aluminum oxide layer, is retained, whereas the abrasive technology largely removes said layer. Cleaning and activating may also take place in two successive steps.

An adhesion promoter may then be applied to the cleaned and activated bond area, with or without its oxide layer. The cleaned and activated bond are may then be chemically transformed in an aftertreatment involving the influence of energy. If, thereafter, the adhesive is applied to the adhesion promoter, effective adhesion properties and a durable adhesive bond are produced.

The above-described pretreatment, i.e., cleaning and activating, of the bond area of the workpiece generates surface conditions which offer the basis for effective adhesion properties of the adhesive layers. For this reason it is advantageous to carry out the bonding of the pretreated workpieces either directly, subsequently or within a time as short as possible, in order to prevent renewed deactivation of the surface.

### Cleaning

In order to improve the bonding of a metal or metal alloy surface with a hydrated oxide and/or hydroxide layer, it is advantageous to alter the surface condition of the oxide and/or hydroxide layer and the degree of contamination. For this purpose a number of mechanical, chemical, and physical methods may be employed, which are described below.

Cleaning generally cleans a bond area of surface contaminants. These contaminants include hydrocarbons such as greases and oils.

Pretreatment of the bond area may partly remove an oxide and/or hydroxide layer on the surface, which has come about already after the production of the workpiece, or convert the oxide and/or hydroxide layer into a durable condition joined firmly to the surface.

An energy supply for pretreatment may be generated with a plasma source or plasma nozzle, wherein a plasma jet is generated from a working gas by a nonthermal discharge between two electrodes in a nozzle tube to which a high voltage of high frequency is applied. The working gas may be under atmospheric pressure, and the plasma may also be referred to as an atmospheric plasma. The method described, however, is not restricted to the use of atmospheric plasmas.

A plasma jet may emerge from the nozzle opening, one of the two electrodes being sited in the region of the nozzle opening. Outside the plasma nozzle, with a suitably adjusted flow rate, a nonthermal plasma jet preferably has no electrical streamers, i.e., discharge channels of the electrical discharge, so that only the high-energy but low-temperature plasma jet is directed onto the adhesion promoter. A plasma jet may also be characterized by reference to a high electron temperature and a low ion temperature. A variety of plasma sources may be utilized, such as those described in EP 0 761 415 A1 and EP 1 335 641 A1.

A plasma jet may preferably be generated by means of atmospheric discharge in an oxygen-containing working gas. This increases the reactivity of the plasma jet. Air may be preferably used as the working gas. It is likewise possible to employ a working gas comprising a mixture of hydrogen and nitrogen, known as forming gas.

A nonthermal plasma discharge may be initiated using a high voltage of a high frequency, a sequence of discharges being generated between two electrodes of the plasma nozzle, wherein the working gas is excited to a plasma which emerges from the plasma nozzle. A high-frequency succession of discharges may advantageously ensure that there is no thermal equilibrium in the discharge chamber. Hence it is possible even in long-term operation to maintain the disequilibrium between electron temperature and ion temperature.

Atmospheric plasma treatment is especially suitable for cleaning when the aim is to obtain largely grease-free surfaces. The effectiveness of the plasma treatment depends, of course, on the choice of process gas, output, treatment duration, and plant design, and a variety of adaptations may be made in view of particular requirements of an application.

The method described above may be employed for, if somewhat less well suited to, the removal of particulate contaminants, examples being shavings or flakes of metal, and inorganic contaminants in the form of salts or fingerprints, which cannot be converted into gaseous products. In particular, the method may be less effective for very thick contamination layers, i.e., contamination by oiling (anticorrosion oils and cutting oils/press oils) or by a dry lubricant, in the order of magnitude of roughly over 4 g/m2. However, removal of such contamination layers may take place iteratively, although this may be more costly. In these cases of contamination, therefore, it is possible to employ other pretreatment methods, either alternatively or in addition to the plasma jet pretreatment.

Besides the pretreatment of the bond area by means of an atmospheric plasma jet, it is also possible to pretreat the bond area mechanically, chemically and/or electrochemically or by means of a beam method (laser, UV light, electron beam). Although these methods may not be as thorough as a plasma pretreatment, these methods may nonetheless likewise be employed.

Cleaning as part of the method of the invention is not restricted, therefore, to plasma treatment. Further examples of pretreatment are the following:
cleaning by washing the bond area with solvents;
mechanical pretreatment by coarse sanding, fine sanding, brushing, sandblasting or CO₂ blasting;
chemical pretreatment by pickling with acidic or alkaline solutions;
thermal methods, e.g., flame treatment;
electrochemical pretreatment by phosphating, chromating, paint-removing or stripping;
physical pretreatment by atmospheric plasma, corona discharge, UV treatment, laser, or atmospheric-pressure or low-pressure plasma.

In the case of sandblasting and in the case of CO₂ blasting, a blasting agent including solid-state particles may be directed at high speed onto the surface to be treated. At the surface, as a result of the impinging particles, a surface material, in particular the aluminum oxide layer, may be deformed, compacted, compressed and/or removed. The result is a rough aluminum material surface with a characteristic appearance. In contrast to many chemical surface treatment methods, blasting is comparatively environment-friendly, and if dust pollution is avoided is also lower risk in terms of workplace safety.

In the case of a low-pressure plasma method, components to be treated may be introduced into a container which is evacuated, and an amount of process gas, such as oxygen and noble gas, is ionized at an internal pressure of 10 to 500 Pa (fine vacuum). The improvement in bond strength depends on the plasma gas employed and on the treatment duration.

Plasma pretreatment and plasma cleaning may have several advantages over the alternative methods, such as:
improved degreasing
no drying needed
suitable for all materials
environment-friendly
low operating costs
readily controllable process
change in surface energy
high bond strength
the bonds are stable over time
applicable for coating operations
very long storage capacity
possibility for rapid integration into manufacturing processes.

### Activation

A bond area may be activated with an atmospheric plasma jet in order to achieve improved wettability and improved reactivity of the bond area for an adhesion promoter. It may be desirable to carry out pretreatment and the activation of the surface in one step, e.g., one application of the plasma jet. Where alternative preparation methods are employed, activation by a plasma jet may occur afterward.

Activation of the bond area, additionally bearing an oxide and/or hydroxide layer, by application of a plasma jet may bring about modification of the oxide and/or hydroxide layer on the surface of the workpiece. In general an oxide and/or hydroxide layer may be in a hydrated form prior to activation, particularly superficially. This may particularly be the case where the oxide and/or hydroxide layer of the metal or metal alloy has been formed in an uncontrolled way in ambient air.

During the supply of energy by the plasma jet, the oxide and/or hydroxide layer is generally dehydrated, initiating a transformation to an oxide layer and, where appropriate, a modification of a crystal structure of the oxide. In other words, water and/or OH groups present in the oxide and/or hydroxide layer are removed. Plasma activation may be particularly effective for this purpose.

A surface layer of hydrated oxide and/or hydroxide which is typically relatively soft prior to treatment, may become consolidated and cured as a result.

Since a principal factor governing activation is a high supply of energy, both oxidizing and nonoxidizing working gases can be employed for plasma generation. Activation of a metal or metal alloy surface, particularly of the aluminum material surface, is also independent of whether discharge channels (streamers) jump over on the surface or not in the course of plasma treatment. Transfer of a high power density to the surface may be a particularly influential factor.

The oxide surface thus modified is chemically active, thereby simplifying attachment of an adhesion promoter.

Surprisingly it has also been found that in the course of activation with a plasma jet, a hydrated oxide and/or hydroxide layer of the metal or metal alloy may solidify such that it may be reliably bonded without the formation of a weak boundary layer.

Another form of abrasive surface activation is CO₂ blasting. In this abrasive method, a hydrated oxide and/or hydroxide layer is substantially removed, so that the metallic surface is exposed. This metallic surface is chemically active, so that—especially where little time elapses—the adhesion promoter is applied to the free surface of the material. Accordingly, during aftertreatment, a direct join may be produced between the adhesion promoter and the metal surface or metal alloy surface. Depending on the material, an unhydrated, controlled oxide layer may form immediately after the free metallic surface has been exposed.

### Adhesion Promoter

An adhesion promoter may generally allow effective adhesion between the metal surface or metal alloy surface and the adhesive. Adhesion promoters may be composed of dilute solutions of the adhesive's base materials, which may also be used for subsequent adhesive bonding.

Adhesion promoters may be applied to the workpieces generally by rolling, spraying or dipping methods and may be flashed off at temperatures below a necessary curing temperature of the adhesive. During the flash-off time, typically a few minutes, solvent present in the adhesion promoter is largely volatilized, and under the influence of atmospheric humidity a crosslinking reaction of the adhesion promoter substance with itself and with the bond surface may occur at least partially. This procedure ensures that the adhesion promoter substance is distributed homogeneously on the bond area treated with adhesion promoter, so that after the subsequent aftertreatment, a particularly effective bond to the metal surface or metal alloy surface and to the subsequently applied adhesive is ensured.

In one embodiment, an adhesion promoter includes a silane.

Use is made in particular of an adhesion promoter which includes at least one adhesion promoter substance which is selected from the group including organosilicon compounds, organotitanium compounds, and organozirconium compounds. These compounds have emerged as being particularly advantageous. However, other compounds may be employed.

An adhesion promoter composition may also include mixtures of at least one organosilicon compound with at least one organotitanium compound and/or at least one organozirconium compound. It may also include mixtures of at least one organotitanium compound with at least one organozirconium compound. An adhesion promoter composition may preferably includes mixtures of at least one organosilicon compound with at least one organotitanium compound.

An adhesion promoter preferably includes a solvent, in particular a volatile solvent. It is therefore possible on the one hand for the adhesion promoter to be applied readily and uniformly, and on the other hand the aftertreatment can be carried out just a short time after the application of the adhesion promoter.

### Aftertreatment

An aftertreatment of the adhesion promoter may be carried out by plasma treatment and, where appropriate, additional heat treatment.

In the course of a plasma aftertreatment energy from a plasma jet is transmitted to an adhesion promoter material. In this case the energy of the plasma gas, which exhibits a high electronic excitation, is at least partly transferred to the adhesion promoter when the plasma strikes the surface of the adhesion promoter.

An aftertreatment of an adhesion promoter may be carried out preferably using a plasma source or plasma nozzle for which a plasma jet is generated from a working gas, which is preferably under atmospheric pressure, by means of a nonthermal discharge between two electrodes in a nozzle tube, wherein a high voltage of high frequency is applied, similar to the mode of operation described above.

A high electron temperature may promote a high transfer of energy to an adhesion promoter, without heating up the material significantly. The particularly influential factor may be a low ion temperature. Chemical energy of electron excitation may be converted directly into a reaction of the material of the adhesion promoter. Accordingly, a chemical reaction of the adhesion promoter with the bond area may be achieved, the bond area exhibiting an exposed metal surface or, preferably, an oxide layer of a metal or metal alloy. This may be particularly helpful in promoting strong binding of a subsequent adhesive bond.

Preferably, therefore, a bond area is aftertreated with an atmospheric plasma jet. Further, the same plasma nozzle may be employed for both pretreatment and aftertreatment.

Furthermore, an adhesion promoter can be subjected not only to the plasma aftertreatment but also to a heat treatment in order to complete the curing reaction. An adhesion promoter may be heated for at least 5 min, preferably at least 10 min, at least 140° C., preferably at least 155° C., and more preferably at least 170° C.

As a result of application of energy through a plasma jet and, where appropriate, through a supply of heat, a chemical reaction may be induced in the adhesion promoter, chemically transforming the adhesion promoter. Since constituents of organic radicals of adhesion promoters, e.g., ESCA, can generally be detected in measurable amounts by means of surface analysis methods, it is generally assumed that the aftertreatment largely decomposes the adhesion promoter substance and that its semimetal or metal atoms, particularly Si and/or Ti and/or Zr, interact with the free metallic surface or with the oxide surface of the metal or metal alloy. It is generally assumed that, in this case, inclusion compounds, optionally alloys, are formed.

This chemical reaction as part of the aftertreatment may cause chemical modification of the surface. After the reaction has ceased, it is generally not feasible to detect a separate layer. As a result of the chemical reaction as part of the aftertreatment, therefore, in contrast to the formation of a further adhesion promoter film with organic constituents, which takes place by hydrolysis and crosslinking of the adhesion promoter substances under the influence of moisture, there is generally no deposition of a layer on the bond area; instead, there may be a chemical modification of the metallic or metal-oxidic surface of the material.

At least for preferred materials, such as aluminum, the activated aluminum oxide layer may have a hexagonal honeycomblike structure, into which the silicon, titanium or zirconium atoms are intercalated by treatment of the adhesion promoter. The resulting structure may be a nanoscale structure.

Finally, under certain circumstances, the adhesion promoter can also be aftertreated through a heat treatment alone.

### Adhesive Bonding

A method of adhesively bonding two workpieces may also be employed, wherein at least one workpiece includes a metal or metal alloy having a hydrated oxide and/or hydroxide layer, and the workpieces each have at least one bond area. A bond area of the at least one workpiece made of a metal or metal alloy having a hydrated oxide and/or hydroxide layer may be treated and prepared for adhesive bonding by treating the bond area. Subsequently an adhesive may be applied to at least one bond area, and the workpieces may be brought into contact with one another at their bond areas. Finally, the adhesive may be cured.

Accordingly, a stable and permanent adhesive bonding of two workpieces, one of which is composed of a metal or metal alloy having a hydrated oxide and/or hydroxide layer. The second workpiece may be composed of the same metal or metal alloy as the first workpiece, or may be composed of another metal or metal alloy having a hydrated oxide and/or hydroxide layer, or of another material, such as plastic or a natural substance. In each case the pretreatment of the bond area promotes effective adhesion of the adhesive to the metal or metal alloy.

There is a large selection of adhesives which are suitable for adhesively bonding workpieces composed of a metal or metal alloy having a hydrated oxide and/or hydroxide layer. For example, one-component and multicomponent adhesives can be used.

One-component adhesives do not require mixing, and consequently may advantageously eliminate errors related to incorrect mixing ratios or deficient mixing.

In some embodiments, one-component adhesives may develop adhesion through physical effects. For example, solvent-based adhesives may be employed which contain nonreactive polymers that are present in the form of solutions or dispersions, and solidify by drying, such as acrylic resin dispersion adhesives, for example. These adhesives may be utilized, but they are generally suitable for bonds where only low forces require transmission and where they are applied over a large area. For structural bonds, in contrast, adhesives of this kind are generally less preferred.

Other examples of adhesives based on a physical development of strength are nonreactive hotmelt adhesives. In this case a thermoplastic polymer may be melted, applied while hot to an adherent surface, and joined immediately or very shortly afterward. A polymer melt solidifies as it cools, thereby bonding the adherents to one another. A broad range of thermoplastic polymers may be employed, allowing the melting temperature, mechanical properties, and adhesion of the hotmelt adhesive to be accordingly varied. One disadvantage of these non-reactive hotmelt adhesives is that the melting is generally a reversible process and, accordingly, there is a risk of liquefication of the adhesive at high temperatures, as a result of which the adhesive bond may decrease in strength or even separate entirely.

Reactive one-component adhesives may also be used. These may include systems which are crosslinked through the use of an energy source. An energy source may include particulate or electromagnetic radiation, such as UV, visible light, IR, microwave, electron or ion radiation, or heat. By way of example, one-component adhesives such as acrylate, epoxy resin, or polyurethane adhesives may be employed.

Adhesives typically employed in this context include a substance which, under the influence of radiation or heat, react or release a substance which reacts with reactive constituents of the adhesives or initiate or catalyze their polymerization.

Examples of such adhesives include thermosetting epoxy resin adhesives or polyurethane adhesives with ingredients such as carboxylic acids, anhydrides, dicyandiamide (dicy), amine adducts with Lewis acids, such as boron compounds or acids, or amine-metal complexes.

Additionally one-component adhesives which include a substance which reacts with ingredients in the air, especially atmospheric humidity, may be utilized. This reaction may even occur at room temperature. These one-component adhesives may include, in particular, polyurethane adhesives, which contain polyisocyanates, particularly in the form of polyurethane prepolymers which contain isocyanate groups, react with the atmospheric moisture, and cure.

A subclass of these adhesives include reactive hotmelt adhesives, in particular reactive polyurethane hotmelt adhesives, which contain either a combination of isocyanate-group-containing prepolymers with thermoplastics, or reactive thermoplastics. Hotmelt adhesives of this kind may be preferred over nonreactive hotmelt adhesives, since on account of the crosslinking through the isocyanate groups they generally do not exhibit any reversible melting behavior.

A further class of moisture-curing one-component adhesives includes polymers containing silane groups as reactive compounds. Adhesives of this kind are generally known as silicon adhesives, MS polymer adhesives or silane-terminated polyurethane adhesives.

Other moisture-curing one-component adhesives include cyanoacrylate adhesives which may generally be known as “superglue”, for example.

Two-component adhesives may advantageously be adapted to include a wide variety of desirable adhesive properties. For example, a variety of different curing components may be employed, according to the requirements of the adhesive application. Accordingly, it is possible to obtain very rapid, extremely rigid or extremely elastic adhesive bonds.

Suitable two-component adhesives include in principle all known adhesives which crosslink by polyaddition or by free-radical polymerization. Generally, mutually reactive components may be stored separately and mixed during or immediately prior to application.

In the case of polyaddition, two types of compounds typically react with one another, these two types being stored separately from one another and being an essential constituent of the respective components. They are typically referred to as resin and the others as hardener.

The adhesives are generally classified by their resin component.

Epoxy resin adhesives comprise compounds having oxirane groups, typically present in the form of glycidyl ethers. The great majority of epoxy resin adhesives include glycidyl ether bisphenols, particularly of bisphenol A and/or bisphenol F, as a basic building block. Hardeners used for two-component epoxy resin adhesives may include, in particular, polyamines and/or polymercaptans. Polyamines may be preferable.

Two-component polyurethane adhesives may include polyisocyanates, particularly in the form of prepolymers containing isocyanate groups. Hardeners employed may include polyamines and/or polyols and/or polymercaptans. Two-component adhesives typically react significantly more quickly than two-component epoxy resin adhesives.

Adhesives which crosslink by free-radical polymerization are a further class of suitable two-component adhesives. In this case one component may be crosslinked through the admixing of an initiator which releases free radicals. Compounds to be crosslinked that form part of the first component typically include compounds containing double bonds. Examples thereof are, in particular, styrenes, vinyl acetates, acrylonitrile, acrylates, and methacrylates. Particularly suitable are acids and esters of acrylic acid and/or methacrylic acid. Typically, peroxides, and especially organic peroxides, may be employed as a free-radical initiator, which constitutes the second component or a constituent thereof. For example, one known initiator is benzoyl peroxide.

These adhesives possess the great advantage of rapid crosslinking and relatively low sensitivity toward mixing errors.

One-component thermosetting epoxy resin adhesives, particularly those with a heightened impact strength, may be generally preferred, such as for body adhesives in vehicle construction applications. Examples are disclosed in EP 1 359 202 A1.

Additionally, one-component polyurethane adhesives of the kind available commercially from Sika Schweiz AG under the product line Sikaflex® may be preferable. These adhesives in particular may be used for adhesive bonding at room temperature.

Preferred two-component adhesives are, in particular, two-component polyurethane adhesives and (meth)acrylate adhesives, of the kind available commercially from Sika Schweiz AG under the product lines SikaPower® and SikaFast® respectively.

These adhesives may be particularly preferable in applications where high cycle times and/or rapid development of strength is desired.

For vehicle construction in particular, bonded workpieces may be coated with a cathodic electrodeposition coating after curing of an adhesive. This generally allows components of the bodywork to be produced which, after the individual components have been bonded, can be coated uniformly and almost without noticeable seam points.

One advantage of the method described of adhesively bonding workpieces made of metals or metal alloys having a hydrated oxide and/or hydroxide layer is that the pretreatment, the application of the adhesion promoter, and the bonding of the workpieces generally may produce a corrosion-protected surface.

A further advantage of various embodiments, is a short operating time for the pretreatment, application, and aftertreatment of the adhesion promoter, and for the bonding. A short operating time may be promoted by rapid pretreatment and aftertreatment with a plasma jet, and also as a result of through a short exposure time of the adhesion promoter.

Furthermore, the treated areas are generally compatible with cathodic electrocoats. The areas are therefore suitable for use in further coating operations.

### Cathodic Electrodeposition Coating

In a further preferred embodiment, a bond area may be coated with a cathodic electrodeposition coating or electrocoating operation. This may be particularly useful for vehicle construction applications because bonded workpieces made from the metals or metal alloys described may be utilized for parts of the body which before and/or after bonding are subjected to a coating operation.

Workpieces may be run through the entire pretreatment operation, and also electrocoating, which are composed of the following worksteps:
pretreatment, including:
   degreasing (dipping at +60° C.)
   rinsing (dipping in plant water)
   activating (dipping)
   phosphating (dipping at +45° C.)
   rinsing (dipping in plant water)
   passivating (dipping)
   rinsing (dipping in DI water)

This process may be followed by electrodeposition coating. Electrodeposition coating is a coating method which utilizes electrochemical processes to deposit anticorrosion coating material. For this purpose an electrodeposition coating system applies a direct voltage to a workpiece which is in suspension in a bath of coating material containing oppositely charged coating-material particles. The coating particles are therefore attracted by the workpiece and deposited on it, where they form a uniform film over the entire surface. In this way every gap and corner is coated, including hidden areas, until the existing attraction is suppressed and the cathodic electrodeposition coating operation ceases. After this has taken place, the workpiece may pass through rinsing zones which operate with fully deionized (DI) water. After leaving the rinsing zones, the coated parts may pass into a baking oven. In this oven the coating film generally undergoes crosslinking and cures, to achieve maximum resistance properties on the part of the coatings.

Therefore it is desirable that the bond area coated with the adhesion promoter can also be coated with the conventional method. In this context it is desirable that not only the bonded bond area, i.e., the adhesive itself, is electrodeposition-coatable, but also that the bond areas bearing adhesion promoter have this property. This is because the region occupied by the adhesive generally does not cover all of the area of the adhesion promoter; instead, beyond the adhesive sections, there are regions whose outer area is covered by the adhesion promoter even after adhesive bonding. These regions too should as far as possible be electrodeposition-coatable, since then the cathodic electrocoat reaches up to the adhesive layer and is therefore itself corrosion-protected. In the region of the bond site, the adhesive generally provides passive corrosion control, and for this purpose an effective adhesion of the adhesive to the surface over—as far as possible—the full area is essential. Passive corrosion control means that the adhesive has a barrier effect toward the substances that lead to corrosion, but does not itself actively prevent corrosion of the surface. Ideally, the adhesion quality of the adhesive is as good as that of the paint film deposited by cathodic electrocoating, or, preferably, is better.

During electrodeposition coating, at least two coats may be applied, the difference in coat thickness typically being less than 25% relative to the finished coat. This produces a uniform and stable structure.

A workpiece having a bond area may be provided, wherein at least the bond area includes a metal or metal alloy having a hydrated oxide and/or hydroxide layer.

As an example, the workpiece may be a vehicle body, especially an automobile body. The workpiece may also be part of a vehicle, in particular of an automobile.

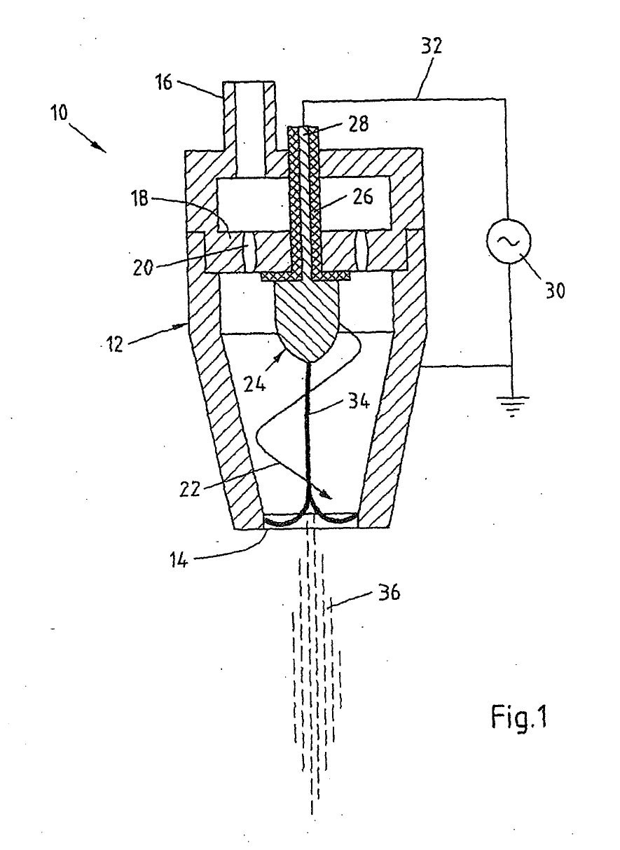

Turning now to FIG. 1, a diagrammatic representation of an exemplary embodiment of a plasma source suitable for implementing the method, and chemical compositions of adhesion promoters is shown.

### Plasma Source

As shown in FIG. 1, a plasma nozzle 10 may include a metal nozzle tube 12 that tapers conically to an outlet opening 14. At the end opposite the outlet opening 14, the nozzle tube 12 may have an inlet 16 for a working gas, e.g., compressed air. An intermediate wall 18 of the nozzle tube 12 has a ring of holes 20, made obliquely in the peripheral direction, and so forms a swirl device for the working gas. The downstream, conically tapered part of the nozzle tube is therefore traversed in flow by the working gas in the form of an eddy 22, whose core extends along a longitudinal axis of the nozzle tube.

Arranged centrally on an underside of the intermediate wall 18 is an electrode 24, which protrudes coaxially into the tapered section of the nozzle tube. The electrode 24 may be formed by a rotationally symmetrical pin which is rounded off at the tip and is made of copper, for example, and electrically insulated by an insulator 26 from the intermediate wall 18 and the other parts of the nozzle tube. Via an insulated shank 28, a high-frequency alternating voltage, generated by a high-frequency transformer 30, may be applied to electrode 24. The voltage may be variably regulable in amounts of, for example, up to 500 V or more, preferably 2-5 kV, and in particular more than 5 kV. The frequency may be within an order of magnitude of 1 to 30 kHz, and preferably in the region of 20 kHz, and is preferably likewise regulable. The shank 28 may be connected to high-frequency transformer 30 via a flexible high-voltage cable 32. Inlet 16 may communicate via a hose (not shown) with a compressed-air source with variable through-put, which may advantageously be combined with the high-frequency generator 30 to form a single supply unit. In this way plasma nozzle 10 can easily be moved by hand or by means of a robot arm. Nozzle tube 12 and the intermediate wall 18 are grounded. As a result of the applied voltage, a high-frequency discharge is generated in the form of an arc discharge 34 between electrode 24 and nozzle tube 12. Owing to the swirling flow of the working gas, however, in the core of the eddy this arc of light is channeled on the axis of the nozzle tube 12, so that it branches only in the region of the outlet opening 14 to the wall of the nozzle tube 12. The working gas, which rotates with a high flow rate in the region of the eddy core and hence in the direct vicinity of the light arc 34, comes into intimate contact with the light arc and is consequently converted in part into the plasma state, with the result that a jet 36 of a relatively cool atmospheric plasma, roughly in the form of a candle flame, emerges from the outlet opening 14 of the plasma nozzle 10.

The embodiment depicted shows one example of a series of different embodiments of plasma sources. Consequently the exemplary embodiment described should not be interpreted as being restrictive for the scope of protection of the subject matter.

### Adhesion Promoter

An adhesion promoter used in the method described may include at least one adhesion promoter substance which is selected from the group including organosilicon compounds, organotitanium compounds, and organozirconium compounds. These compounds have emerged as being particularly advantageous. However, other compounds may be employed.

Examples of organosilicon compounds include all known organosilicon compounds which are used as adhesion promoters. The organosilicon compound preferably carries at least one group which under the influence of water undergoes hydrolysis and leads to formation of a silanol group. Preferably an organosilicon compound of this kind carries at least one, in particular at least two, alkoxy group(s) which is or are attached via an oxygen-silicon bond directly to a silicon atom. Furthermore, the organosilicon compound may carry at least one substituent which is attached via a silicon-carbon bond to the silicon atom and which, if desired, has a functional group which is selected from the group including oxirane, hydroxyl, (meth)acryloyloxy, amino, mercapto, and vinyl group. Organosilicon compounds containing such amino, mercapto or oxirane groups are also referred to as “aminosilanes”, “mercaptosilanes”, or “epoxysilanes”. In particular the organosilicon compound is a compound of the formula (I):

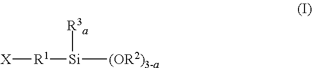

The substituent R¹ here is a linear or branched, optionally cyclic, alkylene group having 1 to 20 Carbon (C) atoms, where appropriate with aromatic fractions, and where appropriate with one or more hetero atoms, particularly nitrogen atoms. The substituent R² may be an alkyl group having 1 to 5 C atoms, such as methyl or ethyl.

Furthermore, the substituent R³ may be an alkyl group having 1 to 8 C atoms, such as methyl, and the substituent X may be an H or a functional group selected from the group encompassing oxirane, OH, (meth)acryloyloxy, amine, SH, and vinyl. Finally, “a” may be selected from one of 0, 1, or 2. Preferably, “a” may be equal to zero.

Methylene, propylene, methylpropylene, butylene or a dimethylbutylene group may be preferable as substituent R¹. Preferably R1 is a propylene group.

Suitable organosilicon compounds are readily available commercially and with particular preference may be selected from the group including 3-methacryloyloxypropyltrialkoxysilanes, 3-aminopropyltrimethoxysilane, bis[3-trimethoxysilyl)propyl]amine, tris[3-(trimethoxysilyl)propyl]amine, 3-aminopropyltriethoxysilane, N-(2-aminoethyl)-3-aminopropyltrimethoxysilane, N-(2-aminoethyl)-3-aminopropyltriethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane, N-(2-aminoethyl)-3-aminopropyldimethoxymethylsilane, 7-amino-4-oxaheptyldimethoxymethylsilane, [(3-(trimethoxysilyl)propyl]urea, 1,3,5-tris[3-(trimethoxysilyl)propyl]-1,3,5-triazine-2,4,6(1H,3H,5H)-trione-urea (i.e., isocyanurate of 3-isocyanatopropyltrimethoxysilane), 3-methacryloyloxypropyltriethoxysilane, 3-methacryloyloxypropyltrimethoxysilane, 3-glycidyloxypropyltrimethoxysilane, 3-glycidyloxypropyltriethoxysilane, 3-mercaptopropyltriethoxysilane, 3-mercaptopropyltrimethoxysilane, vinyltrimethoxysilane, vinyltriethoxysilane, methyltrimethoxysilane, octyltrimethoxysilane, dodecyltrimethoxysilane, and hexadecyltrimethoxysilane, and adducts of epoxysilanes with mercaptosilanes or with aminosilanes.

Examples of preferred adducts of epoxysilanes with aminosilanes or mercaptosilanes are described as reaction product D in EP 1 382 625 A1.

More preferred organosilicon compounds may include aminosilanes, particularly those having primary amino groups, preferably 3-aminopropyltrimethoxysilane, 3-aminopropyltriethoxysilane, N-(2-aminoethyl)-3-aminopropyltrimethoxysilane, N-(2-aminoethyl)-3-aminopropyltriethoxysilane, and mixtures thereof.

Examples of suitable organotitanium compounds include any known organotitanium compounds that are used as adhesion promoters. The organotitanium compound may preferably carry at least one group which under the influence of water undergoes hydrolysis and leads to the formation of a Ti—OH group. An organotitanium compound of this kind may preferably carry at least one functional group which is selected from the group encompassing alkoxy group, sulfonate group, carboxylate group, acetylacetonate, or carries mixtures thereof, and which is attached via an oxygen-titanium bond directly to a titanium atom.

Alkoxy groups which have proven particularly suitable are, in particular, so-called neoalkoxy substituents, particularly of the following formula:

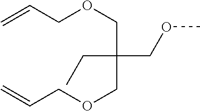

Sulfonic acids which have proven particularly suitable are, in particular, aromatic sulfonic acids whose aromatics are substituted by an alkyl group. Considered preferred sulfonic acids are radicals of the following formula:

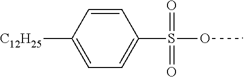

Carboxylate groups which have proven particularly suitable are, in particular, carboxylates of fatty acids. Decanoate is considered a preferred carboxylate.

In all the formulae above the dashed bond here indicates the connection to a titanium atom.

Organotitanium compounds are available commercially, from Kenrich Petrochemicals or DuPont, for example. Examples of suitable organotitanium compounds are, for example, Ken-React® KR TTS, KR 7, KR 9S, KR 12, KR 26S, KR 33DS, KR 38S, KR39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA1, LICA 09, LICA 12, LICA 38, LICA 44, LICA 97, LICA 99, KR OPPR, KROPP2 from Kenrich Petrochemicals or Tyzor® ET, TPT, NPT, BTM AA, AA-75, AA-95, AA-105, TE, ETAM from DuPont. Compounds such as Ken-React® KR 7, KR 9S, KR 12, KR 26S, KR 38S, KR44, LICA 09, LICA 44, NZ 44, and also Tyzor® ET, TPT, NPT, BTM, AA, AA-75, AA-95, AA-105, TE, ETAM from DuPont may be particularly preferred.

Suitable examples of organozirconium compounds include any known organozirconium compounds that are used as adhesion promoters. The organozirconium compound may preferably carry at least one group which under the influence of water undergoes hydrolysis and leads to the formation of a Zr—OH group. An organozirconium compound of this kind may preferably carry at least one functional group which is selected from the group including alkoxy group, sulfonate group, carboxylate group, phosphate or mixtures thereof, and which is attached via an oxygen-zirconium bond directly to a zirconium atom.

Examples of alkoxy groups which have proven particularly suitable include so-called neoalkoxy substituents, particularly those having the following formula:

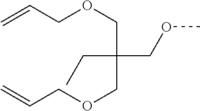

Examples of suitable sulfonic acids include aromatic sulfonic acids whose aromatics are substituted by an alkyl group. Considered preferred sulfonic acids may be radicals of the following formula:

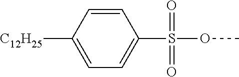

Examples of carboxylate groups which are particularly suitable include carboxylates of fatty acids. Stearate may be a preferred carboxylate.

In all the formulae above the dashed bond here indicates a connection to a zirconium atom.

Organozirconium compounds are generally available commercially, examples including NZ 38J, NZ TPPJ, KZ OPPR, KZ TPP, NZ 01, NZ 09, NZ 12, NZ38, NZ 44, NZ 97 from Kenrich Petrochemicals. Ken-React® NZ 44 may be particularly preferred.

The adhesion promoter composition may include mixtures of at least one organosilicon compound with at least one organotitanium compound and/or of at least one organozirconium compound. It may likewise include mixtures of at least one organotitanium compound with at least one organozirconium compound. The adhesion promoter composition may preferably include mixtures of at least one organosilicon compound with at least one organotitanium compound.

Mixtures of two or more organosilicon compounds or mixtures of one organosilicon compound with an organotitanium compound may be particularly preferred. Mixtures of organosilicon compounds which have proven particularly useful are mixtures of adhesion promoter substances of the formula (I) above, at least one of these substituents H carrying X as substituents, and at least one of these substances carrying a functional group which is selected from the group encompassing oxirane, (meth)acryloyloxy, amine, SH, and vinyl, as substituent X. These mixtures may preferably include at least one alkyltrialkoxysilane with an aminoalkyltrialkoxysilane and/or mercaptoalkyltrialkoxysilane.

Volatile solvents such as water, alcohols, especially ethanol, isopropanol, butanol, aldehydes or ketones, especially acetone, methyl ethyl ketone, hydrocarbons, especially hexane, heptane, cyclohexane, xylene, toluene, white spirit, and mixtures thereof may be preferred. Ethanol, methanol, isopropanol or hexane, and mixtures thereof may be particularly preferred. The solvent content may typically between 0% and 99% by weight, in particular between 50% and 99% by weight, and preferably between 90% and 99% by weight, based on the weight of the adhesion promoter composition. An adhesion promoter composition may further comprise typical additives, especially flow control agents, defoamers, surfactants, biocides, antisettling agents, stabilizers, inhibitors, pigments, dyes or odorants, as may be useful.

It may be advantageous, furthermore, particularly when using a film-forming binder, to employ an adhesion promoter composition which includes a filler. Examples of preferred fillers include carbon blacks, fumed silicas, and chalks having a modified surface where necessary.

An adhesion promoter composition may be prepared in any known manner, typically in the absence of moisture. Following preparation, an adhesion promoter composition may be stored in suitable containers which prevent contact with moisture during storage. Preferred containers may include plastics, glass and metals. Particularly preferred are aluminum containers, especially aluminum flasks with airtight lids.

An adhesion promoter composition may be applied by spraying, in particular as a film, or by cloth, felt or brush application. If a cloth is used, typically a textile, such as a paper towel (Tela or Kleenex®) may be soaked with an adhesion promoter composition and applied to a surface that is to be treated.

1. A method for treating a bond area of a workpiece, the bond area including one of a metal or metal alloy, the one of a metal or metal alloy having one of a hydrated oxide and a hydroxide layer, the method comprising:
cleaning the bond area;
activating the bond area;
coating at least a portion of the bond area with an adhesion promoter; and
chemically transforming the adhesion promoter with an aftertreatment.

2.-26. (canceled)

27. The method of claim 1, wherein cleaning the bond area includes cleaning the bond area with an atmospheric plasma jet.

28. The method of claim 1, wherein cleaning the bond area includes cleaning the bond area with a beam process.

29. The method of claim 28, wherein the beam process includes one of a laser beam, UV light beam, and an electron beam.

30. The method of claim 1, wherein the one of a hydrated oxide and a hydroxide layer is at least partly detached from the workpiece.

31. The method of claim 1, wherein activating the bond area includes activating the bond area with an atmospheric plasma jet.

32. The method of claim 1, wherein the one of a hydrated oxide and a hydroxide layer is one of dehydrated and solidified.

33. The method of claim 32, wherein the one of a metal or metal alloy is a non-ferrous metal material, the non-ferrous material including one of aluminum and an aluminum alloy.

34. The method of claim 1, further comprising using an adhesion promoter, the adhesion promoter including at least one adhesion promoter substance selected from the group including an organosilicon compound, an organotitanium compound, and an organozirconium compound.

35. The method of claim 34, wherein the adhesion promoter includes a solvent

36. The method of claim 35, wherein the solvent includes a volatile solvent.

37. The method of claim 34, wherein the adhesion promoter includes a film-forming binder.

38. The method of claim 34, wherein the adhesion promoter includes a filler.

39. The method of claim 34, further comprising aftertreating the adhesion promoter with an atmospheric plasma jet.

40. The method of claim 39, further comprising heat treating the adhesion promoter.

41. The method of claim 40, wherein the heat treating includes applying a temperature of at least 140 degrees Celsius to the adhesion promoter for at least five minutes.

42. The method of claim 40, wherein the heat treating includes applying a temperature of at least 155 degrees Celsius to the adhesion promoter for at least five minutes.

43. The method of claim 40, wherein the heat treating includes applying a temperature of at least 170 degrees Celsius to the adhesion promoter for at least five minutes.

44. A method of adhesively bonding two workpieces, at least one of the two workpieces including at least one of a metal and a metal alloy having one of a hydrated oxide and a hydroxide layer, the workpieces each having at least one bond area, comprising:
cleaning the at least one bond area of a first workpiece;
activating the at least one bond area of the first workpiece;
coating at least a portion of the at least one bond area of the first workpiece with an adhesion promoter;
chemically transforming the adhesion promoter with an aftertreatment;
applying an adhesive to the at least one bond area of the first workpiece;
bringing the other workpiece into contact with the first workpiece at their at least one bond areas; and
curing the adhesive.

45. The method of claim 44, wherein both workpieces are composed of at least one of a metal and a metal alloy having at least one of a hydrated oxide and a hydroxide layer.

46. The method of claim 45, wherein the at least one of a metal and a metal alloy includes a nonferrous metal material

47. The method of claim 46, wherein the nonferrous metal material is one of aluminum and an aluminum alloy.

48. The method of claim 44, wherein the adhesive includes a one-component adhesive.

49. The method of claim 44, wherein the adhesive includes one of an epoxy resin and a polyurethane.

50. The method of claim 44, wherein the adhesive includes a two-component adhesive.

51. The method of claim 50, wherein the two-component adhesive includes one of an epoxy adhesive and a polyurethane adhesive.

52. The method of claim 44, further comprising employing a curing component.

53. The method of claim 52, wherein the curing component includes one of a polyamine, a polycarboxylic acid, an isocyanate, and a hydroxy-containing resin.

54. The method of claim 44, further comprising coating the bonded workpieces with a cathodic electrodeposition coating.

55. The method of claim 54, wherein at least two electrodeposition layers are applied.

56. The method of claim 55, wherein a difference in thickness between the at least two electrodeposition layers is less than 25 percent of a thinner layer.

57. A workpiece comprising:
a bond area, the bond area including at least one of a metal and a metal alloy having at least one of a hydrated oxide and a hydroxide layer;
wherein the bond area has been cleaned, activated, and coated at least partly with an adhesion promoter; and
further wherein the adhesion promoter has been chemically transformed with an aftertreatment.

58. The workpiece of claim 57, wherein the workpiece includes a vehicle body.

59. The workpiece of claim 57, wherein the workpiece includes a part of a vehicle.
